(19) United States
(12) Patent Application Publication
(10) Pub. No.: US 2010/0091687 A1
(43) Pub. Date: Apr. 15, 2010

(54) STATUS OF EVENTS

(76) Inventors: Ted Beers, Corvallis, OR (US); Diane R. Hammerstad, Corvallis, OR (US); Jon A. Brewster, Monmouth, OR (US); Michael D. Derocher, Albany, OR (US); Mark E. Gorzynski, Corvallis, OR (US); Lonnie D. Mandigo, Corvallis, OR (US); April S. Mitchell, San Jose, CA (US); Kenton O'Hara, Sydney (AU)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/251,631

(22) Filed: Oct. 15, 2008

(51) Int. Cl. H04L 12/16

(52) U.S. Cl. 370/260

(57) ABSTRACT

An event management system is configured to provide first status information corresponding to a scheduled event to at least a first person associated with an in progress event where the in progress event includes a first plurality of event endpoints that provide a first set of media streams to a first set of attendees. The event management system is also configured to provide second status information corresponding to the in progress event to at least a second person associated with the scheduled event where the scheduled event is scheduled to include a second plurality of event endpoints that provide a second set of media streams to a second set of attendees.

### BACKGROUND

Collaboration event systems allow for collaboration between people in different locations. These systems allow participants to interact with one another through the use of audio and video equipment that provides real time audio and video communications. The process of connecting people across various locations may become complex, particularly where different groups of people desire to use part of the same collaboration event system for different collaboration events.

Participants of an in progress event may be aware that a resource of the in progress event may be scheduled for use by scheduled event that follows the in progress event. The in progress event participants, however, may wish to continue to use the resource beyond the time that the scheduled event is set to begin. Separately, the scheduled event participants may not be particularly concerned with beginning the scheduled event on time. A number of scheduled event participants may be running late or the scheduled event may have a low priority, for example.

### BRIEF DESCRIPTION OF THE DRAWINGS

FIG. 1 is a block diagram illustrating one embodiment of a collaboration event system.

FIGS. 2A-2B are block diagrams illustrating embodiments of an event endpoint.

FIGS. 3A-3B are block diagrams illustrating embodiments of configurations of audio/video devices.

FIG. 4 is a flow chart illustrating embodiments of a method performed by an event management system.

FIGS. 5A-5C are block diagrams illustrating embodiments of locations for providing status information.

FIG. 6 is a block diagram illustrating one embodiment of events managed by an event management system.

FIG. 7 is a block diagram illustrating one embodiment of status information provided to events managed by an event management system.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense.

As described herein, an event management system manages collaboration events such as video teleconferences. The event management system maintains registered event specifications for each collaboration event and dynamic event context information that describes the status of collaboration events relative to each other. The event management system uses the registered event specifications and the dynamic event context information to optimize the interaction between collaboration events. The event management system also includes event endpoint information and policies that describe relationships among endpoints and rules associated with endpoints and event attendees.

Along with the status of events, the event management system may be configured to monitor the status of attendees of in progress and scheduled events. The event management system is configured to provide status and attendee information corresponding to the status of attendees to in progress and scheduled events. The status and attendee information allows the attendees of the in progress and scheduled events to make informed decisions about how to proceed with the events.

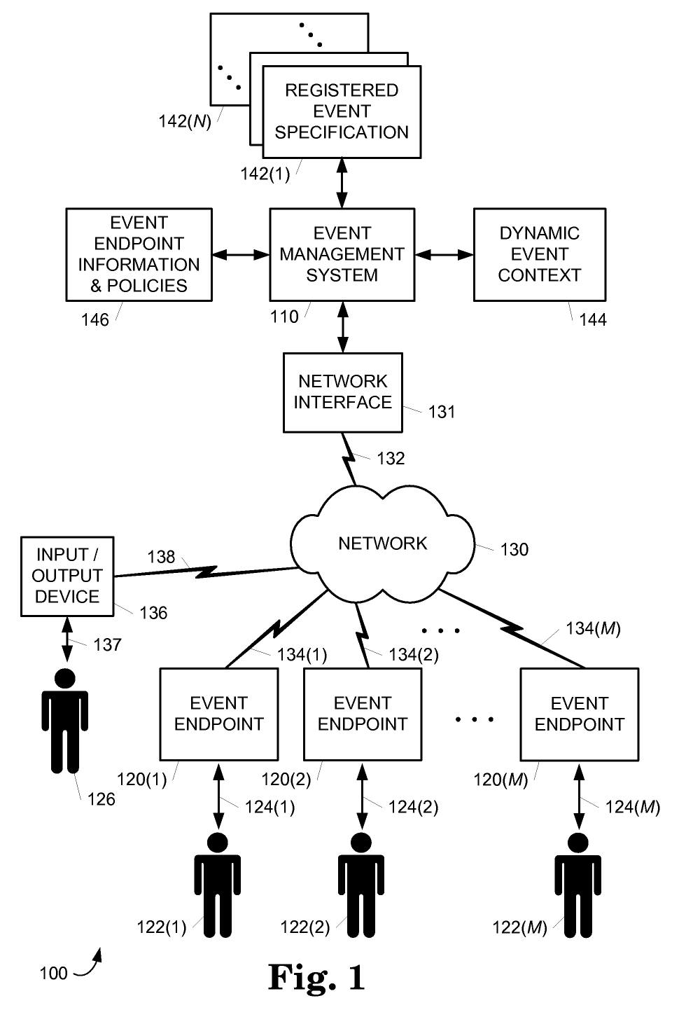

FIG. 1 is a block diagrams illustrating one embodiment of a collaboration event system 100. Collaboration event system 100 includes an event management system 110, a set of event endpoints 120(1)-120(M), and a network 130 that interconnects event management system 110 and event endpoints 120.

Collaboration event system 100 is configured to create and host collaboration events. A collaboration event is an activity with experiential relevance to people, possessing an extension in time and location. Examples of a collaboration event (hereafter “event”) include telepresence videoconferences and meetings conducted using collaboration studio such as a “Halo studio” offered by Hewlett-Packard Co. For each event, collaboration event system 100 exchanges a selected set of audio and/or video (A/V) media streams 124(1)-124(M) between a selected set or subset of event endpoints 120(1)-120(M).

An event includes a set of collaboration system topologies, each of which include a set or subset of event endpoints 120(1)-120(M). An event also includes a registered event specification 142 that specifies information such as a unique identity token, a purpose, a list of event attendees, a list of event resources, contact information of a host of the event, a priority of the event, start and end dates and times, and/or an event duration. Event resources may include event endpoints 120, physical locations (e.g., a collaboration studio or conference room), input/output devices 136 (e.g., interactive touchpoints), and attendees 122.

The collaborative event may take place in two or more locations (e.g., different cities) that each have an event endpoint 120 to connect a set of one or more attendees 122 or media resources in each of the locations. Cameras and microphones, for example, may capture video and audio from one or more of the locations (i.e., at one endpoint) and the video and audio may be output using one or more display devices and speakers, for example, at one or more other locations (i.e., one or more other endpoints). In addition, various types of pre-recorded A/V data, such as content from a DVD, may be transported to one or more of the locations where it may be output using a display device or speakers, for example. One or more locations of the collaborative event may include arrangements of office furniture (e.g., office chairs and a conference table) and A/V gear to provide persons with gaze awareness and a full immersive feeling.

Event management system 110 is configured to initiate, execute, host, and optimize collaboration events using registered event specifications 142(1)-142(N), dynamic event context 144, and event endpoint information and policies 146. Each event is registered with event management system 110, either in advance (i.e., scheduled ahead of time) or in real time (i.e., scheduled on an ad hoc basis), to create a registered event specification 142 for the event using any suitable device for accessing event management system 110 (e.g., an event endpoint 120 or an input/output device 136). Event management system 110 may reference and use each registered event specification 142 for various purposes including preparation for and execution of an event in accordance with the information in a registered event specification 142.

Dynamic event context 144 is real-time information that describes the status of events (e.g., in-progress, interrupted, extended, etc.), the status of events relative to each other (e.g., overlapping or not overlapping based on the start and end times of events), the status of event endpoints 120 and other media resources (e.g., available, reserved, in use or otherwise occupied, or unavailable), and the status of attendees 122 (e.g., checked-in at an event endpoint 120 or elsewhere or not checked-in along with any special privilege indicators or other attendee designations) for each event. Event management system 110 generates and maintains dynamic event context 144 to monitor and manage the real-time system status of collaboration event system 100.

Endpoint information and policies 146 describes the locations, topologies, configurations, and operation policies of event endpoints 120(1)-120(M). Event management system 110 accesses event endpoint information and policies 146 for use in configuring and optimizing collaboration events. Event management system 110 may also reference and use other system information such as the time of day in the process of managing collaboration events.

Each event endpoint 120(1)-120(M) provides a respective set of one or more attendees 122(1)-122(M) with a respective set of one or more audio and/or visual media streams 124(1)-124(M) using network 130. Each event endpoint 120 includes any suitable type, number, and combination of audio and/or visual input and/or output devices that are configured to generate, provide, and/or receive the respective set of media streams 124. Media streams 124 may each be any suitable combination of live or pre-recorded audio and/or video data and/or collaborative data such as XML data that may be combined in any suitable way and output to any number of attendees 122 in any number of event endpoints 120 by collaboration event system 100. Each set of attendees 122(1)-122(M) includes one or more people where the number of people may stay the same, increase, or decrease during the course of an event. In addition, the set of event endpoints 120 for an event may stay the same, increase, or decrease during the course of an event.

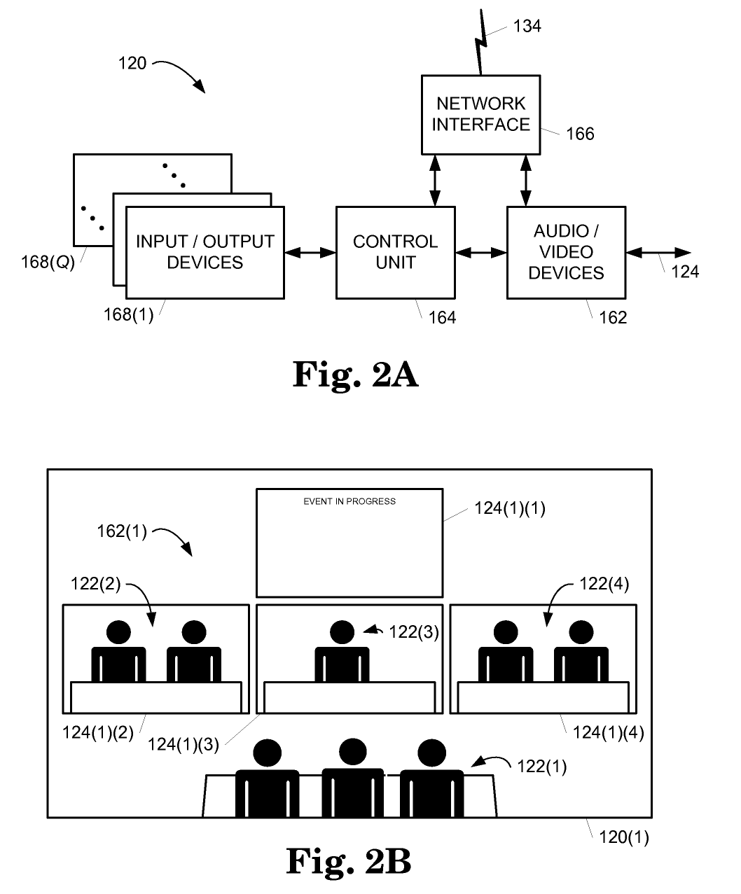

FIGS. 2A-2B are block diagrams illustrating embodiments of event endpoint 120. In the embodiment of FIG. 2A, event endpoint 120 includes a set of one or more audio and/or video (A/V) devices 162, a control unit 164, a network interface 166 and a set of one or more input/output (I/O) devices 168(1)-168(Q).

A/V devices 162 includes any type, number, and combination of audio and/or video input and/or output devices. Examples of A/V input devices include microphones, still and video cameras, media players, and computer and storage systems. The A/V input devices capture, detect, receive or otherwise input live or pre-recorded media streams 124 and provide the input media streams 124 to control unit 164 and/or network interface 166. Examples of A/V output devices include speakers, headphones, headsets, media recorders, and display devices such as projectors, computer monitors, and televisions. The A/V output devices receive media streams from control unit 164 and/or network interface 166 and provide, display, play, or otherwise output live or pre-recorded media streams 124.

Control unit 164 manages the operation of event endpoint 120 by providing control signals and/or other information to and receiving control signals and/or other information from A/V devices 162, network interface 166 and input/output devices 168(1)-168(Q). In some embodiments, control unit 164 may perform processing on media streams received from A/V devices 162 and/or network interface 166 prior to the media streams being provided to network interface 166 or output by A/V devices 162. The processing may include coding or decoding media streams from one media and/or network format to another media and/or network format.

Network interface 166 includes any suitable type, number, and/or combination of network devices that allow event endpoint 120 to communicate with network 130 (shown in FIG. 1) using network connection 134. Network interface 166 receives media streams across network connection 134 and provides the media streams to control unit 164 and/or A/V devices 162. Network interface 166 also receives media streams from control unit 164 and/or A/V devices 162 and provides the media streams to network 130 using network connection 134.

I/O devices 168(1)-168(Q) include any suitable type, number, and/or combination of input and/or output devices that allow attendees 122, administrators, or other persons to communicate with event endpoint 120. The communications may cause event endpoint 120 and/or collaboration event system 100 to perform functions indicated by attendees 122, administrators, or other persons. Examples of I/O devices 168 include interactive touchpoints, display screens, keyboards, and selection or navigation devices (e.g., a mouse, joystick, flywheel, or touchpad).

In other embodiments, the functionality of an A/V device 162 and an I/O device 168 may be included in a single unit such as a laptop computer. In addition, other embodiments may include A/V devices 162 but omit I/O devices 168 or may include I/O devices 168 but omit A/V devices 162.

FIG. 2B illustrates an embodiment of the operation of endpoint 120(1). Endpoint 120(1) provides attendees 122(1) who are present at endpoint 120(1) with media streams 124(1)(1)-124(1)(4) using any suitable type and/or combination of audio/video devices 162(1). Audio/video devices 162(1) are configured to allow for gaze awareness and a full immersion feeling for attendees 120(1).

In the example of FIG. 2B, media stream 124(1)(1) provides information about the event attended by attendees 122(1) (e.g., status information, notifications, configuration options, etc.) and media streams 124(1)(2)-124(1)(4) provide audio and video representations of attendees 122(2)-122(4), respectively, who are present at event endpoints 120(2)-120(4), respectively. Attendees 122(1)-122(4) collectively represent the set of attendees who are present for the event illustrated by the example of FIG. 2B. In other embodiments, endpoint 120(1) may provide other numbers of media streams 124(1) to attendees 120(1) and may have other configurations of audio/video devices 162(1) relative to attendees 120(1).

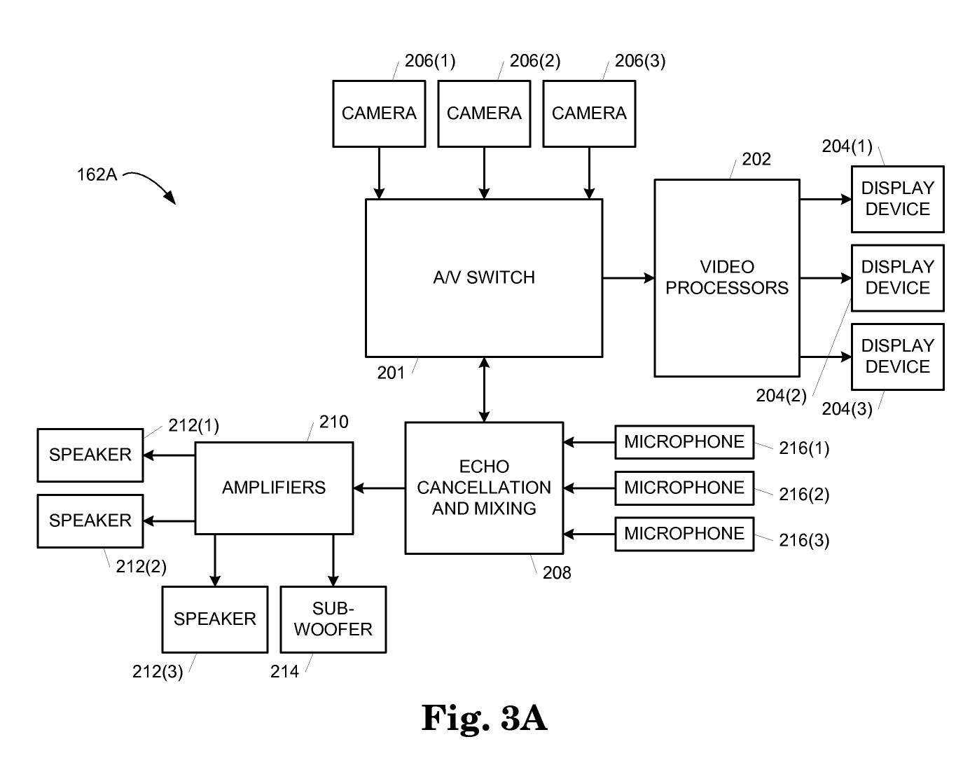

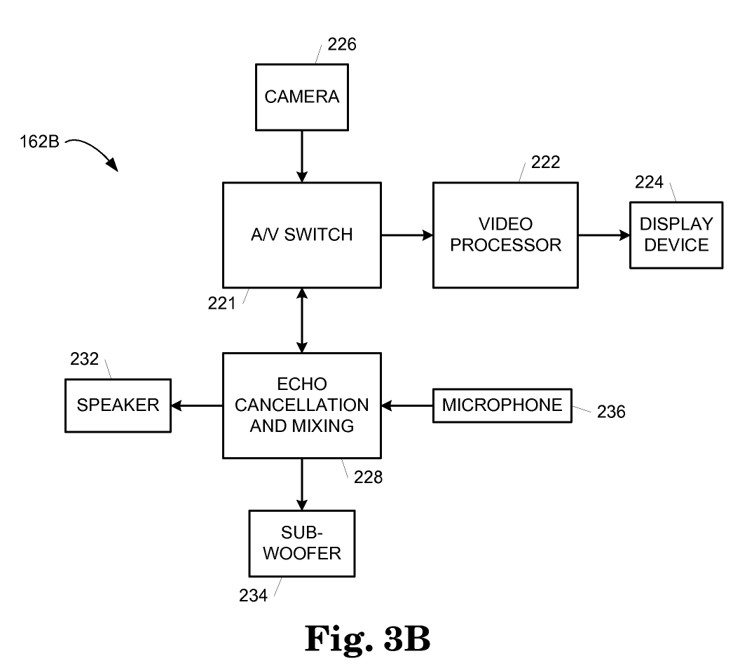

FIGS. 3A-3B are block diagrams illustrating embodiments of configurations of audio/video devices 162.

In one embodiment, A/V devices 162 includes integrated A/V gear that forms a collaboration studio such as a “Halo studio” offered by Hewlett-Packard Co. as shown in the embodiment 162A of FIG. 3A. In the embodiment of FIG. 3A, video processors 202 provide video data from A/V switch 201 to display devices 204(1)-204(3), and display devices 204(1)-204(3) display the video data. Cameras 206(1)-206(3) capture video data and provide the video data to A/V switch 201. An echo cancellation and mixing unit 208 mixes and processes audio data from A/V switch 201 and provides the processed audio data to amplifiers 210. Amplifiers 210 amplify the audio data and provide the audio data to speakers 212(1)-212(3) and sub-woofer 214. Speakers 212(1)-212(3) output the higher frequencies of the audio data, and sub-woofer 214 outputs the lower, bass frequencies of the audio data. Microphones 216(1)-216(3) capture audio data and provide the audio data to A/V switch 201.

Display devices 204(1)-204(3) may be arranged in such a manner around a conference table and chairs to allow for gaze awareness and a full immersion feeling in one embodiment.

In another embodiment, A/V devices 162 includes A/V gear as shown in the embodiment 162B of FIG. 3B. In the embodiment of FIG. 3B, video processor 222 provides video data from A/V switch 221 to display device 224, and display device 224 displays the video data. Camera 226 captures video data and provides the video data to A/V switch 221. An echo cancellation and mixing unit 228 mixes and processes audio data from A/V switch 221 and provides the processed audio data to speaker 232 and sub-woofer 234. Speaker 232 outputs the higher frequencies of the audio data, and sub-woofer 234 outputs the lower, bass frequencies of the audio data. Microphone 236 captures audio data and provides the audio data to A/V switch 221 through echo cancellation and mixing unit 228.

Referring back to FIG. 1, network 130 may be any suitable type of network or combination of networks formed from any suitable number, type, and/or combination of network devices (not shown). The network devices may operate using any suitable network protocol or protocols and may connect to any suitable number of event endpoints 120 or other computer or storage systems. Network 130 may include any suitable combination of secure networks (e.g., enterprise networks or corporate intranets) with limited and secure connections to other systems or unsecure networks with at least one unsecure connection to another system.

Network 130 may be a local, regional, or global network of any suitable network configuration that ranges from local point-to-point connections between event management system 110 and event endpoints 120 to a global array of connections that interconnect event management system 110 and event endpoints 120. Network 130 may be private or publicly available and include one or more connections to the Internet.

Network 130 may be designed specifically to optimize high bandwidth with low latency to be able to transport live, interactive, audio, video, and other data rich media streams. Network 130 may have a smallest link of 45 Mbps, in one embodiment, to avoid any significant serialization delay. Network 130 may also use a flat network topology to minimize latency. In order to keep a high quality end-user experience, network 130 may keep the total one-way latency between any event endpoints 120 to less than one-quarter of a second. This total latency may encompass all aspects of encoding/decoding, encapsulation/de-encapsulation, capture and presentation, filtering, processing, compression and decompression, image compositing, and transport latencies across the transmission path. As the contribution of each component of network 130 to overall latency decreases (as technology improves), the length of the “reach” of where different sites can be physically located may be increased.

To better preserve the shortest paths capable of reliable delivery with little packet loss, bandwidth and network resource mechanisms (not shown) may be used to insure high-quality sessions for the duration of the collaboration session. As most traffic streams are presumed to take place linking a pair or small number of event endpoints 120 together for any given session, event management system 110 may have little presumption of event pre-emption once authorized events commence. In some embodiments, longer latency and/or loss tolerant sessions may be provided over network 130. Such services may include directory, presence, messaging, credential verification, calibration, and time/name services for examples.

The interior of network 130 may concentrate on speedy delivery of traffic flows. Any access control, encryption/decryption and other proxy services, if needed, may occur at the edge of network 130 such as in event endpoints 120 and not the interior of network 130 in some embodiments. This design may make the core of the backbone of network 130 simpler to grow, maintain, stablize, and attain the desired latency.

Event management system 110 connects to network 130 using a network interface 131 and a network connection 132, and event endpoints 120(1)-120(M) connect to network 130 using respective network connections 134(1)-134(M). Each network connection 132 and 134(1)-134(M) may include any suitable type, number, and/or combination of wired or wireless network connections. For example, network connections 132 and 134(1)-134(M) may each be a leased line (i.e., a T3, optical, cable, or wireless high speed link) which provides a large data pipe to and from event management system 110, event endpoints 120(1)-120(M), and input/output device 136, respectively.

Input/output (I/O) device 136 may be any suitable type of device (e.g., a portable or non-portable device such as an interactive touchpoint, a computer, a cell phone, a media player, or a personal digital assistant) configured to communicate with event management system 110 and thereby form an event management client. I/O device 136 is configured to receive inputs from a person 126 and/or provide outputs to person 126 as indicated by an arrow 137. The inputs and outputs may include audio and/or video inputs and outputs. I/O device 136 connects to network 130 using any suitable wired or wireless network connection 138. I/O device 136 may be omitted in some embodiments.

Person 126 may be associated with an event in various ways. For example, person 126 may be an organizer or registered attendee of an event who is identified by registered event specification 142 for the event. Person 126 may also be someone acting on behalf of an organizer or registered attendee identified by registered event specification 142 for the event. Person 126 may further be attempting to register for the event by adding his or her name to registered event specification 142 for the event. In addition, person 126 may be located at or near an event endpoint 120 for the scheduled event.

In operation, event management system 110 initiates, executes, hosts, and optimizes collaboration events using registered event specifications 142(1)-142(N), dynamic event context 144, and event endpoint information and policies 146.

Event management system 110 initiates execution of an event by allocating resources for creating a real-time representation of the event according to the registered event specification 142 of the event to optimize the experience of attendees 122 and 126. The allocated resources include the set or a subset of event endpoints 120 as indicated by the registered event specification 142. Event management system 110 continues execution of the event with changes to the topology of the event (e.g., the addition or removal of event endpoints 120 during the event) to maintain and optimize the experience of attendees 122 and 126 and ends as dictated by the registered event specification 142 or by external inputs (e.g., from an attendee 122 and 126). During execution, event management system 110 may describe an event as being “in-progress”.

In preparation for event execution (i.e., during event preparation) and during event execution, certain activities may be performed by event resources or event management system 110 that impact the management of the event, such as an attendee 122 checking in at an endpoint location, an input/output device associated with an endpoint, or another location. During the course of the lifecycle of an event, additional related artifacts may be added to the event, such as an archive of the execution of the event.

Event management system 110 optimizes event preparation and event execution for each registered event that requires various resources including those resources whose states may impact event preparation and execution. The optimization accounts for resources that may be in use by one or more in-progress events, resources that may be unavailable (e.g., requested for use by another event or out of service), key event attendees 122 that are missing, and other critical event information. Event management system 110 also optimizes event execution for in-progress events by preventing unwanted disruption of an event using resources required by the registered event and by handling requests for resources made by other events.

Event management system 110 performs the optimization using registered event specifications 142 for all related events including the primary event being prepared and other events in progress that are consuming needed resources and dynamic event context information 144 which includes information about event resources (e.g., resources used by other in-progress events and other status information about needed resources). Event management system 110 may also perform the optimization using information provided by attendees, administrators, and/or other persons via I/O devices 168 (shown in FIG. 2A) and/or 136 associated with the event in progress and the registered events and event endpoint information and policies 146. Event endpoint information and policies 146 includes information about the physical and assigned relationships among resources, including relationship information about event endpoints 120 and I/O devices 168 and/or 136, policies regarding the management of shared resources to facilitate optimal event execution, and principles governing the systems behaviors in consideration of the multitude of registered and dynamic information.

Using inputs from registered event specifications 142, dynamic event context information 144, I/O devices 168 and/or 136, and event endpoint information and policies 146, event management system 110 applies event optimization policies to interact with an in-progress event, with related resources such as endpoints 120, and with related input/output devices 168 and/or 136. In doing so, event management system 110 optimizes the experience of attendees 122 such as by event preparation and creating a plan for execution when an overlap is detected between an in-progress event and a scheduled event.

As used herein, the term overlap refers to a commonality of resources between two or more events that may prevent one or more of the events from proceeding as currently defined by the respective registered event specifications 142 for the one or more events. The commonality may be an event endpoint or endpoints 120, an event attendee 122, an event resource (e.g., A/V equipment), or at least a portion of network 130 or network interfaces and connections 132 or 134, for example, where the commonality is not conducive to being used by two or more events at the same time or close to the same time.

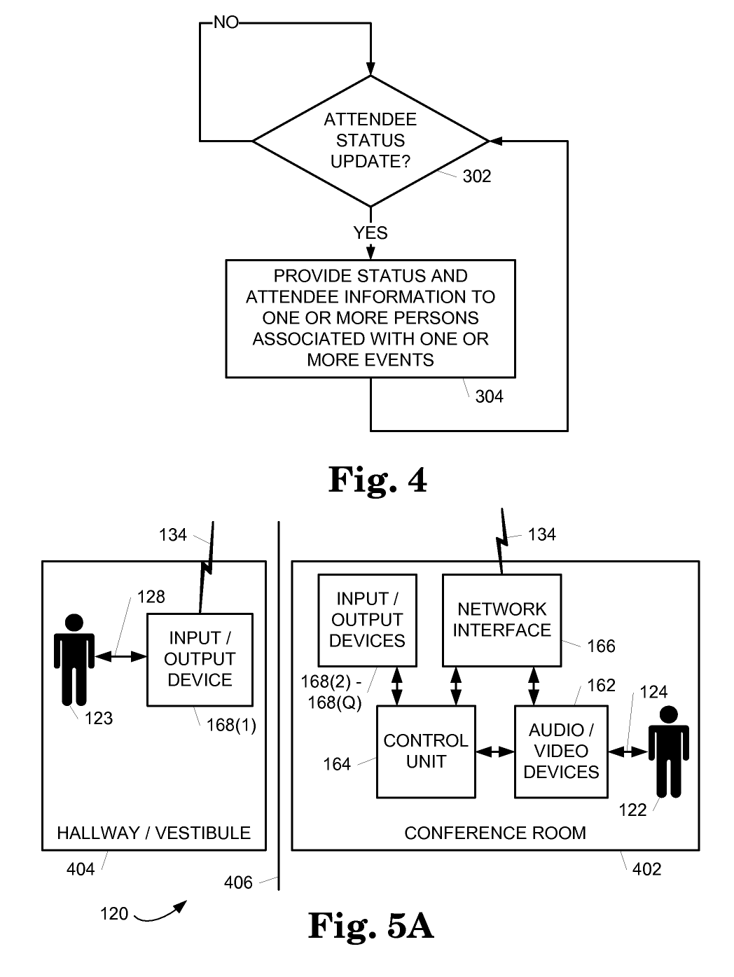

Event management system 110 monitors the status of attendees of in progress and scheduled events and provides status and attendee information corresponding to the status of attendees to persons associated with in progress and scheduled events as illustrated in the embodiment of FIG. 4. FIG. 4 is a flow chart illustrating embodiments of a method performed by an event management system. Attendees of or other persons associated with the in progress and scheduled events use the status and attendee information to make informed decisions about how to proceed with the events, particularly where one or more scheduled events overlap with one or more in progress events.

In the following description of FIGS. 4, 5A-5C, 6, and 7, attendees of in progress events are denoted as attendees 122 and attendees of scheduled events that have not started are denoted as attendees 123. Other persons 126 associated with an in progress and/or scheduled event (not shown in FIGS. 4, 5A-5C, 6, and 7) may also interact with event management system 110.

In FIG. 4, event management system 110 determines whether an attendee status update occurs as indicated in a block 302. An attendee status update occurs in response to a status change associated with an attendee 122 or 123 of an in progress or a scheduled event. The status change may indicate that the attendee 122 or 123 has changed from not present to present or present to not present, for example. The status change also may indicate that the attendee 122 or 123 has registered for an event, canceled a registration for an event, or provided other information regarding the participation of the attendee 122 or 123 in the event (e.g., will be late, need to leave early, etc.).

Event management system 110 detects an attendee status update in response to receiving attendee information corresponding to an attendee 122 or 123 of an in progress of scheduled event or in response to information specified in registered event specifications 142 or dynamic event context 144. The attendee information may specify an action being taken by an attendee 122 or 123, by a person 126, or by an event. For example, an attendee 122 or 123 may check in or otherwise indicate the presence of the attendee 122 or 123 for an event by providing attendee information to event management system 110. In addition, an event may provide attendee information that indicates a change to the event such as the event ending or adding or removing one or more event endpoints 120. Further, event management system 110 may detect an attendee status update based on attendee information in registered event specifications 142, dynamic event context 144, and/or event endpoint information and policies 146.

The attendee information may identify one or more attendees 122 or 123 specifically (e.g., by name or other identifier) or generally (e.g., as an attendee of a designated event or an attendee at an event endpoint location known to event management system 110).

Event management system 110 provides status and attendee information to one or more persons 122, 123, and/or 126 associated with one or more events as indicated in a block 304. Event management system 110 provides the status and attendee information for display or other suitable output by one or more of A/V devices 162, I/O devices 168, and I/O devices 136. For in progress events, A/V devices 162, I/O devices 168, and I/O devices 136 display or otherwise output the status and attendee information to attendees 122 and/or other associated persons 126 of the in progress events. For scheduled events, A/V devices 162, I/O devices 168, and I/O devices 136 at one or more endpoints 120 display or otherwise output the status and attendee information to attendees 123 and/or other associated persons 126 of the scheduled events.

Event management system 110 determines the in progress and scheduled events where the status and attendee information is to be provided using the attendee status update, registered event specifications 142, dynamic event context 144, and event endpoint information and policies 146. Event management system 110 provides the status and attendee information to each in progress and scheduled event that may be impacted by the attendee status update. For example, event management system 110 may provide the status and attendee information to all in progress and scheduled events that overlap. Event management system 110 may also provide the status and attendee information only to one or more attendees 122 or 123 or other associated person 126 of a single event where the event is the only event impacted by the attendee status update.

For in progress events, event management system 110 may provide status and attendee information corresponding to an attendee status update of one or more overlapping or soon to be overlapping events. Event management system 110 may provide the status and attendee information to A/V devices 162 and/or I/O devices 168 at endpoints 120 of the in progress event. In this case, the status and attendee information may indicate the changing crowd of attendees 123 for scheduled events who are present (e.g., present outside of an endpoint 120 of the in progress event or elsewhere), ready to start, and blocked by the in progress event. The status and attendee information may convey, for example, the number of attendees 123 waiting, the percentage of a blocked event's attendees 123 waiting, and/or a number of scheduled events that are blocked by the in progress event.

For scheduled events, event management system 110 may provide status and attendee information corresponding to an attendee status update of other attendees 123 of the scheduled event. For attendees 123 present in an endpoint 120, event management system 110 may provide the status and attendee information to A/V devices 162 and/or I/O devices 168 inside the endpoint 120 where one or more attendees 123 checked in for the scheduled event. For attendees 123 outside of an endpoint 120, event management system 110 may provide the status and attendee information to I/O devices 168 outside of the endpoint 120 where one or more attendees 123 checked in for the scheduled event. For attendees 123 remotely located from an endpoint 120, event management system 110 may provide the status and attendee information to I/O devices 136 where one or more attendees 123 checked in for the scheduled event.

The status and attendee information provided by event management system 110 may indicate the changing crowd of attendees 123 for the scheduled event who are present (e.g., present inside an endpoint 120, present outside of an endpoint 120 of an in progress event, or elsewhere), ready to start, and blocked by an in progress event. For example, the attendee information may provide an indication of how many attendees 123 have checked in for the scheduled event. The status and attendee information may also indicate the changing crowd of attendees 122 for one or more in progress events that block the scheduled event. For example, the status information may convey a remaining event duration, an event priority, and/or other relevant information to the one or more in progress events.

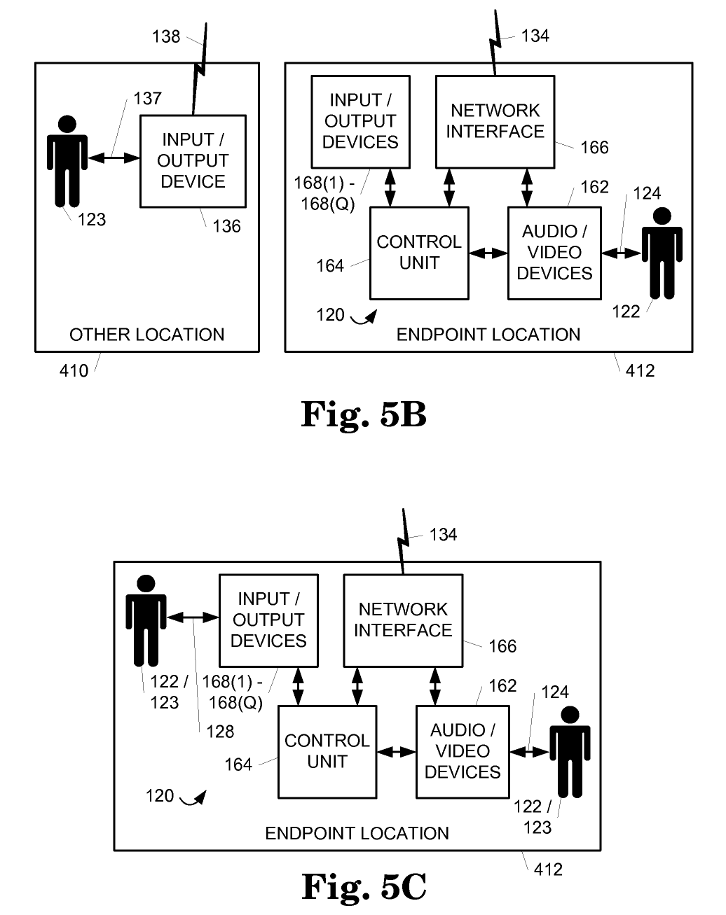

Using the embodiment of FIG. 4, attendees 122 or 123 or other associated persons 126 may provide the attendee information to event management system 110 using an input/output device 168 or 136 from any suitable location. Attendees 122 or 123 or other associated persons 126 may receive the status and attendee information from event management system 110 using A/V devices 162, I/O devices 168, and/or I/O devices 136. FIGS. 5A-5C are block diagrams illustrating embodiments of locations for providing status and attendee information. FIGS. 5A-5C illustrate at least three possible locations where attendee 122 or 123 may receive status and attendee information from event management system 110.

In the embodiment of FIG. 5A, attendee 123 accesses an input/output device 168(1) (e.g., an interactive touchpoint or touchpad display) of an event endpoint 120 to provide attendee information to event management system 110. In the embodiment of FIG. 5A, event endpoint 120 includes a conference room 402 and a hallway or vestibule 404 outside of conference room 402 as indicated by a barrier 406. Barrier 406 may be a wall, a door, a corridor, or other suitable physical structure or space that separates conference room 402 from hallway or vestibule 404. Input/output device 168(1) is located in hallway or vestibule 404 adjacent to conference room 402. Input/output device 168(1) is associated with event endpoint 120 with a physical connection (e.g., network connection 134) or other information that specifies the physical arrangement of input/output device 168(1) in event endpoint 120. Accordingly, attendee 123 may use input/output device 168(1) without visually or audibly interrupting an in progress event taking place in conference room 402.

Audio/video devices 162 of endpoint 120 that provide media streams 124 to attendees 122 of an in progress event and/or capture media streams 124 from attendees 122 of the in progress event are located inside conference room 402. Input/output device 168(1) is located outside conference room 402. Although other components of endpoint 120 are shown as being inside conference room 402 in the embodiment of FIG. 5A, some or all of these components may be located outside of or adjacent to conference room 402 in other embodiments (e.g., in a control room (not shown)).

In the embodiment of FIG. 5B, attendee 123 accesses an input/output device 136 (e.g., a mobile device) to provide attendee information to and receive status and attendee information from event management system 110. In the embodiment of FIG. 5B, an event endpoint 120 of an in progress or scheduled event resides at an endpoint location 412. Attendee 123 uses input/output device 136 from any other location 410 that may be remotely located from or in close proximity to endpoint location 412. Input/output device 136 has no physical relationship with endpoint location 412 or event endpoint 120 in the embodiment of FIG. 5B. Input/output device 136 may form a virtual association with endpoint location 412 or event endpoint 120 through communications with event management system 110. Attendee 123 may use input/output device 136, as indicated by arrow 137, in conjunction with event management system 110 to receive status and attendee information of an in progress or scheduled event in endpoint location 412.

In the embodiment of FIG. 5C, one or more attendees 122 or 123 access any of input/output devices 168(1)-168(Q) (e.g., an interactive touchpoint or touchpad display) inside of event endpoint 120 to provide attendee information to and receive status and attendee information from event management system 110. Attendees 122 or 123 126 use an input/output device 168, as indicated by arrow 128, in conjunction with event management system 110 to provide attendee information to and receive status and attendee information from other in progress and/or scheduled events. The status and attendee information from event management system 110 may be included as part of media streams 124.

In response to receiving attendee information from an attendee 122 or 123, event management system 110 associates attendee 122 or 123 with an in progress or a scheduled event by determining a relationship between attendee 122 or 123 and an in progress or a scheduled event. The relationship may depend on an identity of attendee 122 or 123 or a location of attendee 122 or 123.

In one embodiment, event management system 110 associates attendee 122 or 123 with an in progress or a scheduled event by matching attendee information received from attendee 122 or 123 (e.g., a name, an event code, or other identifier) with information in a registered event specification 142 for the in progress or the scheduled event.

In another embodiment, event management system 110 associates attendee 122 or 123 with an in progress or a scheduled event by matching location information received from attendee 122 or 123 with location information in a registered event specification 142 for the in progress or the scheduled event and/or event endpoint information and policies 146. With the embodiment of FIG. 5A, for example, event management system 110 may recognize input/output device 168(1) as the source of a communication from an attendee 123 and determine that attendee 123 is outside of conference room 402 of event endpoint 120 using event endpoint information and policies 146 which specifies a location of input/output device 168(1). Event management system 110 may further identify a scheduled event that is scheduled to include conference room 402 of event endpoint 120 using a registered event specification 142 for the scheduled event or an in progress event that currently includes conference room 402 of event endpoint 120 using a registered event specification 142 for the in progress event. From these determinations, event management system 110 may associate attendee 123 with the scheduled event.

After associating an attendee 122 or 123 with an in progress or a scheduled event, event management system 110 may associate the in progress or the scheduled event with one or more other events. In one embodiment, event management system 110 identifies an overlap of resources between the events using registered event specifications 142 and/or dynamic event context 144. The overlap of resources provides the basis for associating the scheduled event and the one or more in progress events. In other embodiments, event management system 110 bases the association between the events on other suitable criteria using registered event specifications 142 for the events, dynamic event context 144, and/or event endpoint information and policies 146.

In some embodiments, registered event specifications 142 and/or event endpoint information and policies 146 may indicate that one or more in progress events are not to be disturbed (i.e., no status or attendee information is to be sent during the event). If so, then event management system 110 does not provide status or attendee information to such events.

Using the status and/or attendee information provided by event management system 110, attendees 122 and/or 123 and/or other associated persons 126 may make informed decisions about how to proceed with their events and resolve any overlap between events. For example, attendees 122 may decide to conclude their event in response to all attendees 123 of an overlapping scheduled event being present. As another example, attendees 123 may reconfigure their event in response to an overlapping in progress event extending beyond a scheduled end time. Once any event overlap is resolved by attendees 122 and/or 123, event management system 110 may allocate event endpoints 120 and any other resources to an event to initiate the event and deallocate event endpoints 120 and any other resources from an event to conclude the event.

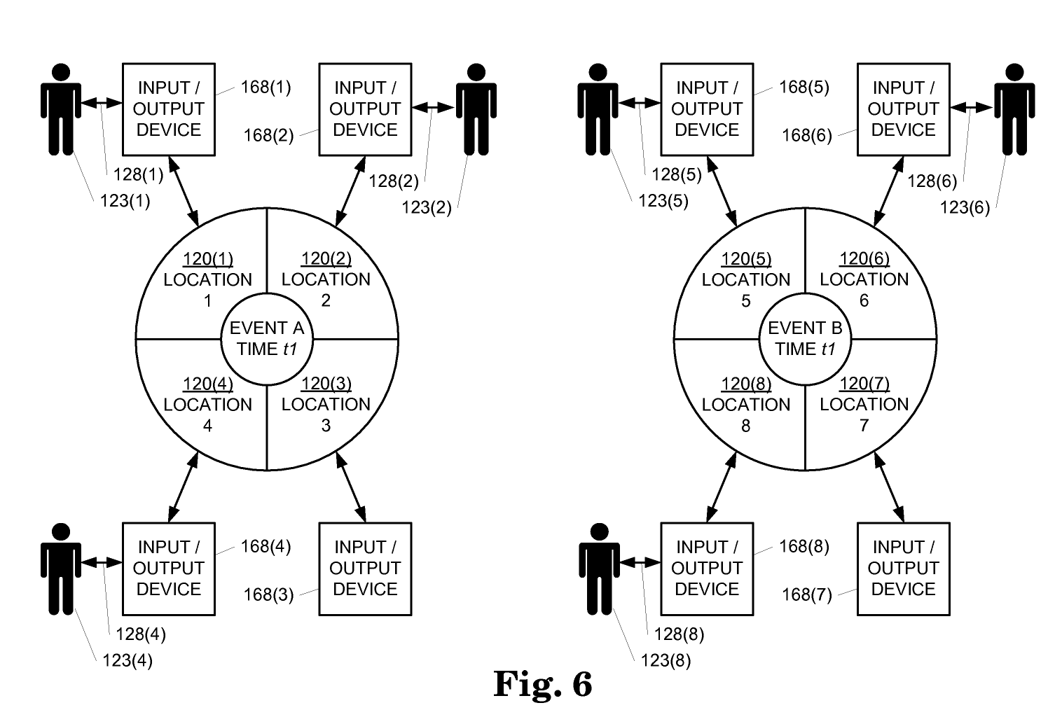

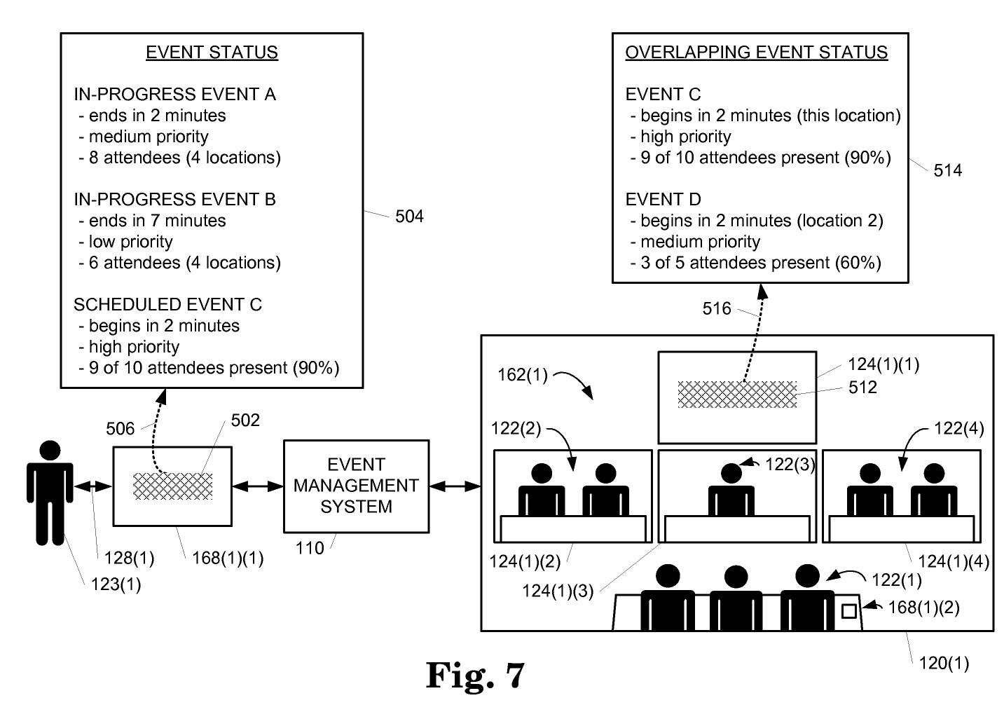

An example of the use of the status and attendee information provided by event management system 110 to events will now be described with reference to FIGS. 6 and 7. FIG. 6 is a block diagram illustrating one embodiment of in progress events A and B managed by an event management system 110 at time t1. Scheduled events C, D, and E are scheduled to begin around time t1. FIG. 7 is a block diagram illustrating one embodiment of status and attendee information provided to events A and C by an event management system.

As shown in FIG. 6, in progress event A includes event endpoints 120(1)-120(4) at locations 1-4, respectively, at time t1. Event B includes event endpoints 120(5)-120(8) at locations 5-8, respectively, at time t1. A scheduled event C is set to begin at or around time t1 and is scheduled, per a registered event specification 142, to include event endpoints 120(1), 120(4), 120(5), and 120(6). A scheduled event D is set to begin at or around time t1 and is scheduled, per a registered event specification 142, to include at least event endpoint 120(2). A scheduled event E is set to begin at or around time t1 and is scheduled, per a registered event specification 142, to include at least event endpoint 120(8).

One or more scheduled event C attendees 123(1) arrive at a vestibule (e.g., vestibule 404 as shown in FIG. 5A) outside of endpoint 120(1) at or around time t1. Attendees 123(1) check in for the scheduled event with event management system 110 using an input/output device 168(1) in the vestibule of event endpoint 120(1) as indicated by arrow 128(1). Similarly, other sets of one or more scheduled event C attendees 123(4), 123(5), and 123(6) arrive outside of respective endpoints 120(4), 120(5), and 120(6) at or around time t1 and check in with event management system 110 using respective input/output devices 168(4), 168(5), and 168(6). In addition, one or more scheduled event D attendees 123(2) arrive at outside of endpoint 120(2) at or around time t1 and check in with event management system 110 using an input/output device 168(2), and one or more scheduled event E attendees 123(8) arrive at outside of endpoint 120(8) at or around time t1 and check in with event management system 110 using an input/output device 168(8).

As shown in FIG. 7, event management system 110 provides status and attendee information to one or more attendees 122(1) of event A and one or more attendees 123(1) of event C. Event management system 110 may also provides status and attendee information to other attendees 122 of event A and other attendees 123 of event C. Event management system 110 may further provides status and attendee information to attendees 122 of in progress event B, attendees 123 of scheduled event D, and/or attendees 123 of scheduled event E.

For attendees 123(1) of event C, event management system 110 provides status and attendee information 504 that is displayed in a display area 502 of input/output device 168(1)(1) as indicated by an arrow 506. Event management system 110 may also provide status and attendee information 504 to attendees 123(4), 123(5), and 123(6) (not shown). In the example of FIG. 7, event management system 110 provides status and attendee information 504 to attendees 123(1) that indicate the status of events A, B, and C and attendees 122 and 123 for events A, B, and C. The status and attendee information for event A, which includes endpoint 120(1), indicates that event A ends in 2 minutes, has a medium priority, and has 8 attendees 122 in 4 locations. The status and attendee information for event B indicates that event B ends in 7 minutes, has a low priority, and has 6 attendees 122 in 4 locations. The status and attendee information for event C indicates that event C is scheduled to begin in 2 minutes, has a high priority, and that 9 of 10 attendees 123 are present (90%). In response to status and attendee information 504, sets of attendees 123(1), 123(4), 123(5), and 123(6) of event C may confer and collectively decide how to proceed.

Event A is shown in FIG. 7 from the viewpoint of event endpoint 120(1) and includes sets of attendees 122(1)-122(4) at event endpoints 120(1)-120(4), respectively. Media streams 124(1)(2)-124(1)(4) depict sets of attendees 122(2)-122(4) at event endpoints 120(2)-120(4), respectively, using the set of audio/video devices 162(1) at event endpoint 120(1). A media stream 124(1)(1) includes status and attendee information 514 from event management system 110 which is displayed in a display area 512 by an audio/video device 162(1) as indicated by an arrow 516. Status and attendee information 514 indicates the status of events C and D and sets of attendees 123 for events C and D. Media streams 124 in the remaining event endpoints 120(2)-120(4) may also display status and attendee information 514 from event management system 110 simultaneously with the display of status and attendee information 514 by event endpoint 120(1).

The audio/video device 162(1) of event endpoint 120(1) displays status and attendee information 514. The status and attendee information for event C, which includes endpoint 120(1), indicates that event C is scheduled to begin in 2 minutes at location 1, has a high priority, and has 9 of 10 attendees 123 present (90%). The status and attendee information for event D indicates that event D is scheduled to begin in 2 minutes at location 2, has a medium priority, and has 3 of 5 attendees 123 present (60%). In response to status and attendee information 514, sets of attendees 122(1)-122(4) of event A may confer and collectively decide how to proceed.

The remaining attendees 122 and 123 of events B, D, and E may also confer and decide how to proceed using status and attendee information from event management system 110.

In addition to or in place of the steps taken by attendees 122 and 123, event management system 110 may include algorithms that cause specific functions to be performed in response to detecting predetermined states of attendee and/or status information using registered event specifications 142, dynamic event context 144, and/or event information and policies 146. Such functions may include initiating the beginning or ending of an event and/or dynamically adjusting of one or more events.

In the above embodiments, event management system 110 may include any suitable combination of hardware and software components. In one embodiment, event management system 110 includes one or more programs that is stored in any suitable type, number, and/or combination of portable or non-portable storage media (not shown) within or otherwise accessible to event management system 110. The programs are accessible to and executable by any suitable type, number, and/or combination of processors (not shown) in event management system 110 to perform the functions described above.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the optical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited by the claims and the equivalents thereof.

What is claimed is:

1. A method performed by an event management system, the method comprising:
providing first status information corresponding to a scheduled event to at least a first person associated with an in progress event, the in progress event including a first plurality of event endpoints that provide a first set of media streams to a first set of attendees; and
providing second status information corresponding to the in progress event to at least a second person associated with the scheduled event, the scheduled event being scheduled to include a second plurality of event endpoints that provide a second set of media streams to a second set of attendees.

2. The method of claim 1 further comprising:
providing the first status information to at least one of the first set of attendees during the in progress event; and
providing the second status information to at least one of the second set of attendees prior to the scheduled event.

3. The method of claim 1 wherein at least one of the first plurality of event endpoints overlaps with at least one of the second plurality of event endpoints.

4. The method of claim 1 further comprising:
providing the first status information to one of the first set of attendees in response to receiving attendee information from one of the second set of attendees.

5. The method of claim 4 further comprising:
receiving the attendee information from an input/output device that is located outside of a room that includes a set of audio/video devices of one of the first plurality of event endpoints.

6. The method of claim 4 further comprising:
associating the one of the second set of attendees with the scheduled event in response to receiving the attendee information; and
detecting an overlap between the scheduled event and the in progress event in response to associating the one of the second set of attendees with the scheduled event.

7. The method of claim 5 further comprising:
associating the one of the second set of attendees with the scheduled event using a registered event specification corresponding to the scheduled event.

8. The method of claim 5 further comprising:
associating a location of the one of the second set of attendees with the scheduled event using event endpoint information.

9. The method of claim 1 further comprising:
providing attendee information corresponding to the second set of attendees to one of the second set of attendees of the scheduled event.

10. A program product comprising:
a program executable by a processor for causing the processor to:
detect attendee information corresponding to a first set of attendees of a scheduled event, the scheduled event being scheduled to include a first plurality of event endpoints that provide a first set of media streams to the first set of attendees; and
provide the attendee information to at least one of a second set of attendees of an in progress event, the in progress event including a second plurality of event endpoints that provide a second set of media streams to the second set of attendees;
a medium that stores the program so that the program is accessible by the processor.

11. The program product of claim 10 wherein the program is executable by the processor for causing the processor to:
detect the attendee information in response to one of the first set of attendees checking in for the scheduled event.

12. The program product of claim 11 wherein the program is executable by the processor for causing the processor to:
detect that the one of the first set of attendees has checked in from one of a hallway or a vestibule that is adjacent to a room that includes a set of audio/video devices of the one of the second plurality of event endpoints.

13. The program product of claim 10 wherein the attendee information provides an indication of how many of the first set of attendees have checked in for the scheduled event.

14. The program product of claim 10 wherein the program is executable by the processor for causing the processor to:
provide status information corresponding to the in progress event to the first set of attendees.

15. The program product of claim 10 wherein the program is executable by the processor for causing the processor to:
provide status information corresponding to the scheduled event to the first set of attendees.

16. A system comprising:
a network interface configured to connect to a network; and
an event management system coupled to the network interface, including a first registered event specification of a scheduled event that is scheduled to include a first plurality of event endpoints that provide a first set of A/V media streams to a first set of attendees;
wherein the event management system is configured to detect a first presence of a first one of the first set of attendees at a first location that is outside of a room that includes a set of audio/video devices of one of the first plurality of event endpoints using the network interface, and wherein the event management system is configured to provide information that indicates a second presence of a second one of the first set of attendees at a second location to the first one of the first set of attendees at the first location using the network interface in response to detecting the first presence.

17. The system of claim 16 further comprising:
the first plurality of event endpoints; and
a second plurality of event endpoints configured to provide a second set of A/V media streams to a second set of attendees during an in progress event.

18. The system of claim 17 wherein the one of the first plurality of event endpoints overlaps with one of the second plurality of event endpoints.

19. The system of claim 17 wherein the event management system includes a second registered event specification of the in progress event.

20. The system of claim 18 wherein the event management system includes dynamic event context information that indicates relative status of the scheduled and the in progress events.
